(19) United States
(12) Patent Application Publication
(10) Pub. No.: US 2023/0246836 A1
(43) Pub. Date: Aug. 3, 2023

(54) Method for cryptographically linking a physical object that has an NFC tag associated therewith to a digital version of the physical object using an NFT

(71) Applicant: LUXVERITY, LLC, Carson City, NV (US)

(72) Inventors: David C. WENTKER, San Francisco, CA (US); Mike LINDELSEE, South Lake Tahoe, CA (US); Thomas M. BARRON, San Francisco, CA (US); Jon W. KIMMINS, Reno, NV (US); Kimberly K. HOLTZ MACMILLAN, San Mateo, CA (US)

(21) Appl. No.: 17/993,278

(22) Filed: Nov. 23, 2022

Related U.S. Application Data
(60) Provisional application No. 63/304,769, filed on Jan. 31, 2022.

(51) Int. Cl. H04L 9/32; H04L 9/00; G06K 19/07

(52) U.S. Cl. CPC H04L 9/3213; H04L 9/50; G06K 19/0723

(57) ABSTRACT

A method is provided to cryptographically link a physical object to a digital version of the physical object and to maintain in a database of an object management system data regarding the physical object and the digital version of the physical object. The digital version of the physical object is represented as a digital file. The object management system includes a data record for a Near Field Communication (NFC) tag that is associated with the physical object. The NFC tag has a memory and a secure process for obtaining access to the memory. A hash generator generates a Non-Fungible-Token (NFT) of the digital file. The generated NFT of the digital file is added to the database in the data record for the NFC tag. Data related to the generated NFT of the digital file is added to the memory of the NFC tag by a cryptographically secure process, thereby cryptographically linking the physical object to a digital version of the physical object via the NFC tag that is associated with the physical object.

### CROSS-REFERENCE TO RELATED APPLICATIONS

This application claims priority to copending U.S. Provisional Patent Application No. 63/304,769 filed Jan. 31, 2022, which is incorporated by reference herein.

### FIELD OF THE INVENTION

The present invention is an innovation of control mechanisms for enhancing and authenticating physical and digital artwork enabling hereto unknown functionality. Specifically, this innovation enables consumers to authenticate physical artwork with a microchip attached to the physical artwork and utilize that same microchip as an authentication means for gaining access to a Non-Fungible-Token (NFT) and secure access to the associated digital version of the artwork which is referenced in the NFT and has been registered on a blockchain.

### BACKGROUND

Collectors of physical art collect art not only for its beauty but also for its value as an investment. Art collectors are beginning to accept the possibility that digital art can also have lasting value, especially if the production and distribution of it is done in a manner where scarcity can be maintained. In the past, digital art was not viewed as being something of value because by its very nature as digital files, an unlimited number of identical copies can be produced by computers. Thanks to the introduction of Non-Fungible-Tokens (NFT), an application of blockchain technology, there is now a clear opportunity for unique instances of digital art to be identified, authenticated, and sold.

In today's world of art, collectors want to own and enjoy physical art which they can always do when they are in physical proximity to it; but they also have an interest in viewing and experiencing their art when they are not in physical proximity to it. Accessing a digital version of the same art using the many digital media devices they use in their everyday lives is an obvious solution to the problem.

While collectors can take photos of their art, those photos do not have any investment or resale value and may not have the full digital experience an artist intends who provides digital versions of their physical art. An NFT version of the art controlled by the artist provides this needed combination of digital art and value. However, NFT technology is very complex and not yet something the average art collector can understand or have success using. What is needed is a simple yet secure means for artists to bundle digital versions of their art with their physical art thereby delivering art collectors the value of their art in both physical and digital forms while also removing the technical complexity of NFT technology for art collectors.

### SUMMARY OF THE INVENTION

Objects and advantages of the invention will be set forth in part in the following description, or may be obvious from the description, or may be learned through practice of the invention. Described are mechanisms, systems, and methodologies related to distribution, authentication, and access of digital art with physical art, enabling hitherto unknown levels of functionality, security, and flexibility.

This invention is a system for managing physical art, digital art, and Non-Fungible-Tokens (NFTs) together via secure microchips attached to physical art and a computing system referred to as an Art Management System. The Art Management System is responsible for managing, authenticating and communicating with the microchips, storing information about physical art, storing digital art files, storing information about the digital art files, and storing and managing NFTs associated with the digital art.

In a preferred embodiment the microchips are based on tamper-resistant microprocessor hardware manufactured with an ISO/IEC 14443 contactless communications interface which enables it to communicate with any Near Field Communication (NFC) enabled mobile phone or device, and the microchip is embedded in a label that can be attached to or affixed to physical art in a manner which prevents the removal of the label without destroying the microprocessor.

The microchips contain security data, data related to NFTs for an associated digital version of the art, and authentication capabilities that can be used to authenticate the physical art as well as provide secure access to the associated NFT and digital version of the art.

Described are a number of mechanisms and methodologies that provide practical details for reliably producing the Art Management System, microchips, and interfaces to associated systems to create a simple, secure, solution to the challenge of distributing digital art through the distribution of physical art.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is an exemplary block diagram of a prior art interface between an NFC Tag communicating with a consumer's NFC-enabled mobile device, where the consumer's mobile device also includes a WiFi or cellular data interface to communicate with any Internet-connected system;

FIG. 2 is a representative schematic graphical overview of a preferred embodiment of the invention illustrating the components involved in the setup of the NFC Tags, physical Art, digital Art, NFTs, and associated systems;

FIG. 3 is a flow diagram illustrating the process from FIG. 2 for setting up an NFC Tag in the Art Management System and attaching it to a physical art piece;

FIG. 4 is a flow diagram illustrating the process from FIG. 2 of adding a digital version of an art piece and associated NFT to the Art Management System and linking to an NFC Tag;

FIG. 5 is a flow diagram illustrating the process from FIG. 2 of accessing a digital version of an art piece associated with an NFT using a mobile phone and NFC Tag attached to a physical art piece.

FIG. 6 is a data table that illustrates how a cryptographic link is made between an NFC Tag and NFT data related to a digital art piece.

### DETAILED DESCRIPTION OF PREFERRED EMBODIMENTS

Reference will now be made in detail to examples of the present invention, one or more embodiments of which are illustrated in the figures. Each example is provided by way of explanation of the invention, and not as a limitation of the invention. For instance, features illustrated or described with respect to one embodiment may be used with another embodiment to yield still a further embodiment. It is intended that the present application encompass these and other modifications and variations as come within the scope and spirit of the invention.

Certain terminology is used herein for convenience only and is not to be taken as a limitation on the present invention. The words “a” and “an”, as used in the claims and in the corresponding portions of the specification, mean “at least one.” In the context of this invention, discussions utilizing terms such as “providing”, “receiving”, “responding”, “verifying”, “challenging”, “generating”, “transmitting”, “authenticating”, or the like, often refer to the actions and processes of an electronic computing devices and/or system. The electronic computing device and/or system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

The abbreviation “NFC” denotes “Near Field Communication”. Also, in the context of this invention, the term NFC Tag refers to a microprocessor chip and integrated radio frequency antenna compatible with the NFC radio frequency communication standard. Examples of microprocessor chips used in NFC Tags for this invention are SmartMX™ designed by NXP Semiconductors, and NTAG® DNA also designed by NXP Semiconductors. Both are a dedicated computer on a chip or microprocessor, embedded in a packaging with multiple physical security measures which give it a degree of tamper resistance. The chip communicates with ancillary devices via a contactless NFC interface according to ISO/IEC 14443. The packaging of the NFC Tag in a preferred embodiment is a printed label with adhesive where the label substrate is silicone in which the NFC chip and antenna are embedded.

The term “physical art piece” refers to art in any physical medium such as painting on canvas, pastel on paper, sculpture, and the like.

The term “digital art piece” is a digital representation of the physical art piece which may be stored as a digital image in any computer readable image file format such as JPEG, PNG, SVG, and the like.

A “mobile phone” as used herein is a portable electronic device owned by the consumer that is equipped with an NFC interface suitable for communicating with the NFC Tag and the device also includes Internet access.

Before describing the present invention, it is useful to first provide a brief description of the current state of the art of NFC Tag usage. The concept is to ensure that a common lexicon is established of existing systems prior to describing the present invention.

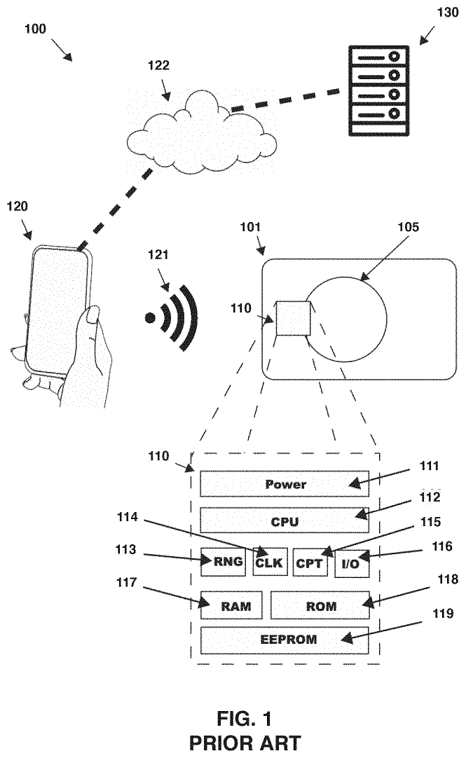

With reference now to FIG. 1, a block diagram of an embodiment of a typical prior art NFC system 100 is shown. The system consists of an NFC Tag 101 with a microprocessor 110 and ISO/IEC 14443 compatible antenna 105, a consumer device 120 (handheld phone shown) with NFC data communication capabilities 121 and an optional Internet connection 122 to a server system 130. The microprocessor 110 communicates 121 with the consumer device 120 via ISO/IEC 14443—a communications standard that is supported both in the NFC Tag 101 and the NFC hardware of the consumer device 120. The consumer device 120 communicates with the server system 130 via a WiFi or cellular data connection 122.

A functional detail of microprocessor 110 includes: Power 111 converter, a Central Processing Unit (CPU) 112, a Random Number Generator (RNG) 113, a connection for an external Clock 114 provided by the I/O port 116, a Cryptographic Coprocessor (CPT) 115, an Input/Output (I/O) port 116, Random Access Memory (RAM) 117, Read-Only Memory (ROM) 118, and Electronically Erasable Programmable Read Only Memory (EEPROM) 119. Device-unique firmware and data can be stored and run from ROM 118 or EEPROM 119 and could, optionally, rely on the support of the RNG 113 and CPT 115 for many of the operations. A microprocessor 110 is also typically packaged with multiple physical security measures which give it a degree of tamper resistance which is important when the microprocessor is included in devices designed for use in security-sensitive applications.

One common device form that includes these types of microprocessors as depicted in FIG. 1, 100 is an NFC Tag 101 where the microprocessor 110 is embedded in some type of substrate such as a plastic card, paper label, silicon label, plastic or special metal enclosure, etc. Radio Frequency (RF) antenna 105 which is connected to the microprocessor 110 is also embedded in the substrate, where the Radio Frequency (RF) antenna 105 provides the interface for power through radio frequency induction and communication with ancillary devices such as the consumer device 120 via the ISO/IEC 14443 communications standard.

Thus, in this FIG. 1 illustration 100, the microprocessor 110 is capable of multiple, secure, autonomous operations and is able to communicate with a remote system 130 by using the consumer device 120 as a communications conduit or relay. The consumer device 120 plays the role of this conduit by using its NFC capability 121 to communicate with the microprocessor 110 and then relays messages received from the microprocessor 110 to the server system 130 using the WiFi or cellular data communications 122 capability of the consumer device 120. The reverse flow is also possible with a message originating on the server system 130 that is sent to the consumer device 120 which then sends the message on to the microprocessor 110.

Having concluded the discussion of exemplary prior art in NFC systems, various embodiments of the present invention will now be disclosed. As will be apparent to one skilled in the art, the present invention overcomes many of the inherent disadvantages and limitations of distributing, accessing, and authenticating digital art.

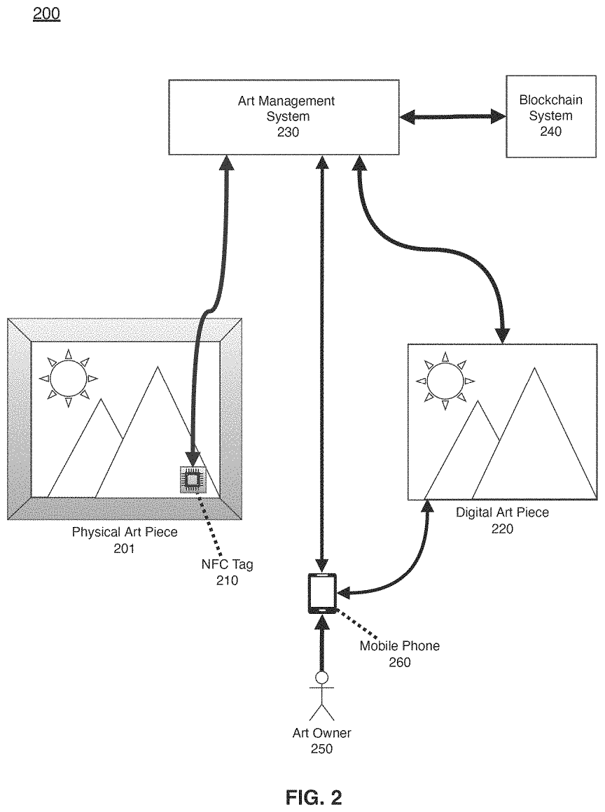

In a preferred embodiment 200 of FIG. 2, the following components are involved: a Physical Art Piece 201 in the form of a painting on canvas; an NFC Tag 210 physically attached to the canvas, preferably on the rear of the canvas where it will not damage the painted front surface; a Digital Art Piece 220 which is a digital version of the painting held in a standard computer readable image file format such as JPEG; an Art Management System 230 which is a cloud-based computing system with security and a database system to manage data about the Physical Art Piece 201, storage of the Digital Art Piece 220, data about the Digital Art Piece 220, data and security data for the NFC Tag 210; a Blockchain System 240 which is responsible for generating a Non-Fungible-Token (NFT) for the Digital Art Piece 220. It should be noted that the Blockchain System 240 is illustrated as a system outside of the Art Management System 230 because this preferred embodiment relies on public blockchain system such as Ethereum® which is used by, but not controlled by, the Art Management System 230. In an alternative embodiment, the Blockchain System 240 may be implemented as a component within the Art Management System 230 in which case the Blockchain System 230 would be considered a private blockchain system.

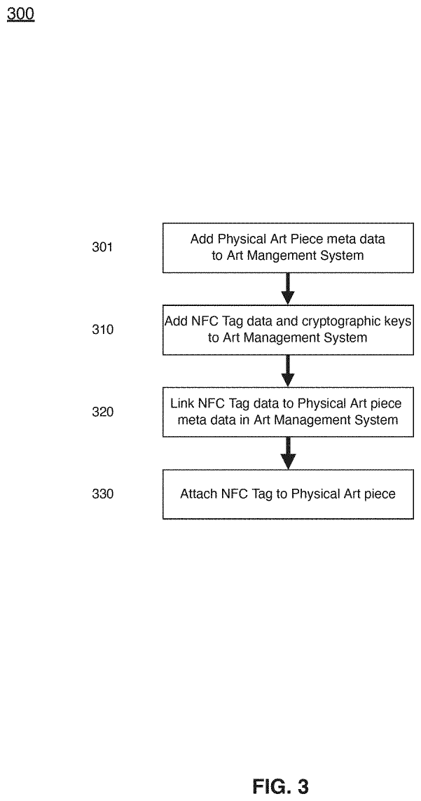

FIG. 3 illustrates the process flow 300 for setting up the Physical Art Piece 201 and NFC Tag 210 in the Art Management System 230 of FIG. 2.

The first step 301 involves the data entry of data related to the Physical Art Piece 201 that is to be added to the Art Management System 230. This data is referred to as the Physical Art Piece meta data. This data entry can occur via any standard process either manually involving keyboard data entry or programmatically if the data is already available in a computer readable format.

The second step 310 involves the data entry of data related to the NFC Tag 210 which is intended to be attached to the Physical Art Piece 201. This data entry is typically done programmatically by importing data that was generated during the manufacturing process of the NFC Tag. This data includes security data which is essential for supporting authentication of the NFC Tag as well as other security operations in the invention.

The third step 320 involves the programmatic linking of the Physical Art Piece meta data to the NFC Tag data so that the Art Management System can maintain the relationship between the NFC Tag 210 and the Physical Art Piece 201 to which the tag is physically attached.

The final step 330 involves the physical attachment of the NFC Tag 210 to the Physical Art Piece 201. As described above, in this preferred embodiment, the NFC Tag 210 is embedded in a silicone substrate creating a label with a secure adhesive that ensures a strong bond with the canvas. Any attempts to remove the NFC Tag 210 label will result in the destruction of the NFC Tag where it can no longer be read, or the condition wherein the NFC tag can be read but the reading of the Tag results in a digital message indicating that the tag has been damaged/removed. In both cases, attempts to move the NFC tag from one Physical Art Piece 201 to another art piece will result in the purchaser having the ability to suspect some type of fraud or counterfeiting has taken place by attempting to read the NFC tag 201. IDENTIV is one of the well-known label manufacturers that produces NFC tags which perform as described above, and which are suitable for use in the present invention to provide such a tamper detection feature.

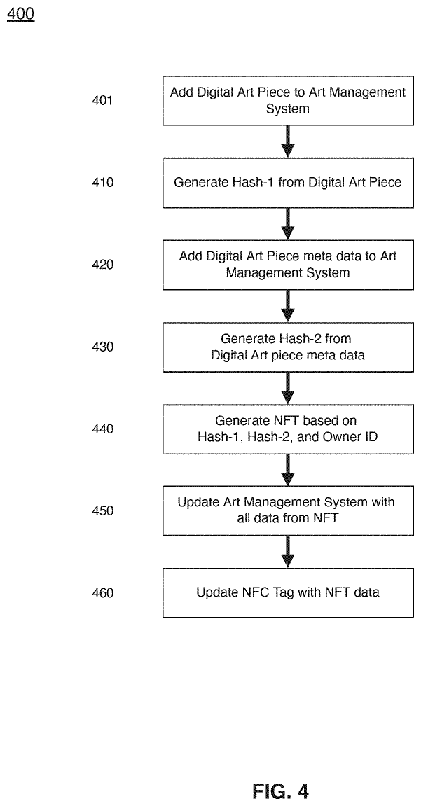

FIG. 4 illustrates the process flow 400 for setting up the Digital Art Piece 220 in the Art Management System 230 and Blockchain System 240 of FIG. 2 and updating the data in the NFC Tag 210 also of FIG. 2.

The first step 401 involves the loading of the digital image file of the Digital Art Piece 220 into the Art Management System 230. This loading would typically be performed programmatically where the digital image file is then stored in a secure file system or database within the Art Management System 230.

The second step 410 involves the generation of a hash (Hash-1) of the Digital Art Piece 220 file which has been loaded to the Art Management System 230 in step 401. Those skilled in the art of cryptographic operations understand there are several well-known and commonly used methods for hash generation such as the Secure Hash Algorithm 1 (SHA-1) which would take the Digital Art Piece 220 file as an input and produce a 160-bit (20-byte) hash value. The hash value is stored in the Art Management System 230. The choice of hash type is determined by the generation of the Non-Fungible-Token which specifies the type of hash required as an input.

The third step 420 involves the data entry of data related to the Digital Art Piece 220 that is to be added to the Art Management System 230. This data is referred to as the Digital Art Piece meta data. This data entry can occur via any standard process either manually involving keyboard data entry or programmatically if the data is already available in a computer readable format.

The fourth step 430 involves the generation of a hash (Hash-2) of the Digital Art Piece meta data which has been loaded to the Art Management System 230 in step 420. The hash method for Hash-2 would follow the same method used in Hash-1. The hash value is stored in the Art Management System 230.

The fifth step 440 involves the generation of a Non-Fungible-Token (NFT) via the Blockchain System 240. This generation is a well understood cryptographic process which requires the following inputs: Hash-1, Hash-2, Owner ID. The most widely used public blockchain system for NFTs is Ethereum. The Owner ID is typically an account ID and in the Ethereum system it is an Ethereum Account ID. As is well-known in the art, the hashes (Hash-1, Hash-2) are generated by a hash generator.

The sixth step 450 involves the updating of the Art Management System 230 with all data from the NFT. This updating would be done programmatically via a connection between the Art Management System 230 and Blockchain System 240.

The final step 460 involves the programmatic addition of data in the NFC Tag 210 to add data related to the NFT. This addition of data ensures that the NFC Tag 210, which is physically bound to the Physical Art Piece 201, is also cryptographically bound to the NFT which represents the Digital Art Piece 220.

The updating of the NFC Tag 210 requires mutual authentication between the Art Management System 230 and NFC Tag 210 using a strong cryptographic operation such as the Advanced Encryption Standard (AES) where the security keys and data of the NFC Tag 210 are held in the Art Management System 230 as described in step 310 of FIG. 3. In a preferred embodiment where a large number of Physical Art Pieces 201 are getting set up in the system, the communication between the Art Management System 230 and NFC Tag 210 would occur via a high-volume NFC tag processing machine with ISO/14443 communications capabilities.

In an alternative embodiment where a very small volume or individual Physical Art Pieces are getting set up in the system by an artist or gallery owner, a consumer device could be used to provide the communication between the NFC Tag 201 and Art Management System 230 as illustrated in FIG. 1.

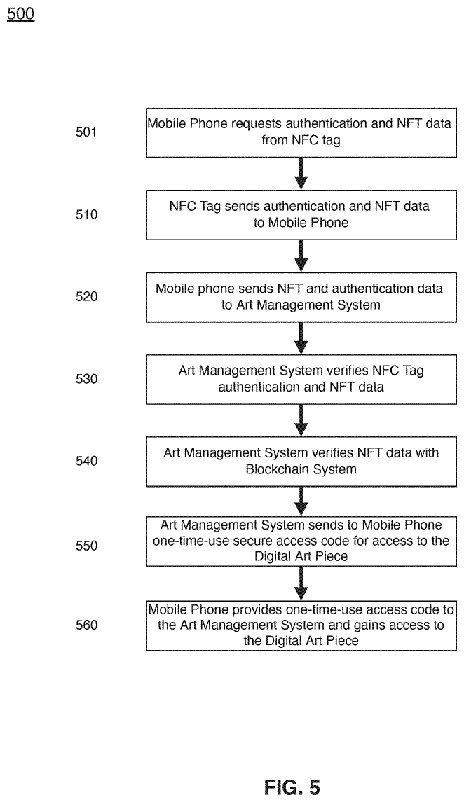

FIG. 5 illustrates the process flow 500 of accessing the Digital Art Piece 220 using a Mobile Phone 260, the NFC Tag 210 attached to the Physical Art Piece 201, the Art Management System 230, and the Blockchain System 240 of FIG. 2.

The first step 501 involves the Art Owner 250 using their Mobile Phone 260 to request authentication and NFT data from the NFC Tag 210. This request is performed by the NFC communications capability of the Mobile Phone 260 which can communicate with the NFC Tag 210.

The second step 510 involves the sending of the authentication and NFT data from the NFC Tag 210 to the Mobile Phone 260. In a preferred embodiment, this data is cryptographically signed by the NFC Tag 210 using the AES algorithm and security keys in the NFC Tag 210 so that it can be verified by the Art Management System 230 to have originated from the NFC Tag 210 and to ensure that the data has not been modified in transit from the NFC Tag 210 to the Art Management System 230.

The third step 520 involves the Mobile Phone 260 sending a request to the Art Management System 230 to gain access to the Digital Art Piece 220 by providing the Art Management System 230 with the cryptographically signed authentication and NFT data returned from the NFC Tag 210. The Mobile Phone 260 is not a trusted component in the security model of this preferred embodiment and therefore is not able to verify this data from the NFC Tag 210.

The fourth step 530 involves the Art Management System verifying the NFC Tag 210 authentication and NFT data. In a preferred embodiment this verification would be done by the Art Management System 230 identifying the appropriate security keys for the NFC Tag 210 as referenced in the authentication data and then using those keys with the AES algorithm to verify that the data has not been modified.

The fifth step 540 involves the Art Management System verifying the NFT data with the Blockchain System 240 to identify the Digital Art Piece 220 file location which is stored within the Art Management System 230 as previously described.

The sixth step 550 involves the Art Management System 230 cryptographically generating a one-time-use access code and sending the code to the Mobile Phone 260.

The final step 560 involves the Mobile Phone 260 sending the one-time-use access code to the Art Management System 230 to gain access to the Digital Art Piece 220. It should be noted that repeated access to the Digital Art Piece 220 requires additional interactions with the NFC Tag 210 and generation of additional one-time-use access codes by the Art Management System 230.

In summary, NFC tags are in wide use in many applications today, including the protection of physical assets such as artwork and collectibles. NFC tags are also used in conjunction with blockchain systems and NFTs to provide traceability of physical assets in supply chain management and the like. Blockchain technology and NFTs are also now being used for tracking ownership of digital art. The present invention provides a novel way of integrating and enhancing these technologies to create a means to distribute NFT digital art with physical art, while also solving two key problems in the world of NFT digital art: simplicity in accessing the digital art, and security to protect access to the art to prevent anyone from making copies of the digital art as is easily done today in NFT systems.

From a user's perspective, the Art Owner 250 gets an NFT version of the art that they purchase in physical form. The process for accessing the NFT digital art is simple and seamless where the Art Owner 250 uses their Mobile Phone 260 to read the NFC Tag 210 and all the rest of the interactions above are completed without any further input from the Art Owner 250. This simplicity is significantly different from the steps required by users today to gain access to a digital image associated with an NFT where registration, creation of wallets and the installation of one or more blockchain software packages is typically required on the user's desktop computer, mobile phone, or both.

The security design in this system where the Digital Art Piece 220 file is securely stored in the Art Management System 230 and requires the NFC Tag 210 data and the generation of one-time-use codes by the Art Management System 230 to gain access to the Digital Art Piece 220 solves the problem identified with NFT art pieces today where anyone can gain access to Blockchain System 240 data and access all digital image files associated with NFTs without any access control or protection whatsoever.

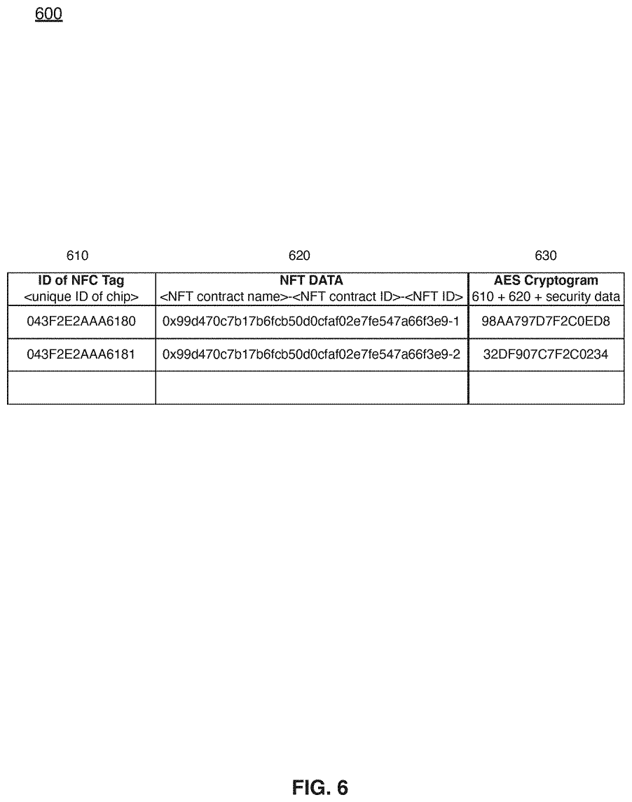

FIG. 6 further illustrates an example embodiment 600 of how data and security within the NFC Tag 210 provides a cryptographic link between the NFC Tag 210 and the NFT data related to Digital Art Piece 220. 610 is an example of a chip ID which is unique per NFC Tag 210. 620 is the unique NFT data that is stored in the chip as described in step 460. 630 is the cryptographic hash which is generated using the chip ID 610 with the NFT data 620 plus security data such as cryptographic keys, counters, and the like. In a preferred embodiment, this cryptographic hash is generated every time the NFC Tag 210 is read, however there are other models for generating and security the data and hash within the chip and external to the chip that are well understood by those skilled in the art of NFC tags and cryptographic systems.

The preferred embodiment described above is directed to a “physical art piece” and a “digital art piece.” However, the present invention is equally applicable to other types of physical objects and digital versions or digital representations of the physical objects (i.e., non-art objects). Similarly, the Art Management System 230 for such non-art objects may be an object management system. The same object management system may also be used to manage art and non-art objects.

In one preferred embodiment which uses the Ethereum blockchain, the data related to the NFT that is stored in the memory of the NFC tag includes at least the smart contract address and token identifier of the NFT. More generically, the data related to the NFT that is stored in the memory of the NFC tag is data that uniquely identifies the NFT.

The data related to the NFT that is stored in the memory may also depend upon the size of the memory. A larger memory size allows more data related to the NFT to be stored, such as the URL of the smart contract for the NFT, which allows for quicker access to the smart contract itself.

To summarize the processes described above, a method is provided to cryptographically link a physical object to a digital version of the physical object and to maintain in a database of an object management system data regarding the physical object and the digital version of the physical object. The digital version of the physical object is represented as a digital file. The object management system includes a data record for a Near Field Communication (NFC) tag that is associated with the physical object. The NFC tag has (i) a unique identifier, (ii) memory, and (iii) a security key that is used for obtaining access to the memory. The method operates as follows:

1. A hash generator generates a Non-Fungible-Token (NFT) of the digital file by:

(i) generating a first hash value of the digital file,

(ii) generating a second hash value of metadata of the digital file, and

(iii) generating the NFT of the digital file using the first hash value and the second hash value.

2. The generated NFT of the digital file is added to the database in the data record for the NFC tag.
3. Data related to the generated NFT of the digital file is added to the memory of the NFC tag by:

(i) communicating a cryptographically secure message to the NFC tag, the secure message requesting to update the memory of the NFC tag with data related to the generated NFT of the digital file,

(ii) cryptographically verifying by the NFC tag the cryptographically secure message using the security key stored in the NFC tag,

(iii) allowing access to the memory of the NFC tag when verification occurs, and

(iv) adding the data related to the generated NFT of the digital file to the memory of the NFC tag, thereby cryptographically linking the physical object to a digital version of the physical object via the NFC tag that is associated with the physical object.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A method for cryptographically linking a physical object to a digital version of the physical object, and maintaining in a database of an object management system data regarding the physical object and the digital version of the physical object, the digital version of the physical object being represented as a digital file, the object management system including a data record for a Near Field Communication (NFC) tag that is associated with the physical object, the NFC tag having (i) a unique identifier, (ii) memory, and (iii) a security key that is used for obtaining access to the memory, the method comprising:
(a) generating, using a hash generator, a Non-Fungible-Token (NFT) of the digital file by:
(i) generating a first hash value of the digital file,
(ii) generating a second hash value of metadata of the digital file, and
(iii) generating the NFT of the digital file using the first hash value and the second hash value; and
(b) adding the generated NFT of the digital file to the database in the data record for the NFC tag; and
(c) adding data related to the generated NFT of the digital file to the memory of the NFC tag by:
(i) communicating a cryptographically secure message to the NFC tag, the secure message requesting to update the memory of the NFC tag with data related to the generated NFT of the digital file,
(ii) cryptographically verifying by the NFC tag the cryptographically secure message using the security key stored in the NFC tag,
(iii) allowing access to the memory of the NFC tag when verification occurs, and
(iv) adding the data related to the generated NFT of the digital file to the memory of the NFC tag, thereby cryptographically linking the physical object to a digital version of the physical object via the NFC tag that is associated with the physical object.

2. The method of claim 1 wherein the object is artwork.

3. The method of claim 1 wherein the NFC tag that is associated with the physical object is affixed to the physical object.

4. The method of claim 1 wherein the data related to the generated NFT of the digital file includes a smart contract address and a token identifier of the NFT of the digital file.
